(19) United States
(12) Patent Application Publication
(10) Pub. No.: US 2018/0336191 A1
(43) Pub. Date: Nov. 22, 2018

(54) METHOD FOR MULTI-SENSE FUSION USING SYNCHRONY

(71) Applicant: Ashwin P. Rao, Kirkland, WA (US)

(72) Inventor: Ashwin P. Rao, Kirkland, WA (US)

(21) Appl. No.: 15/982,636

(22) Filed: May 17, 2018

Related U.S. Application Data
(60) Provisional application No. 62/507,365, filed on May 17, 2017.

(51) Int. Cl. G06F 17/28; G06K 9/62; G06F 3/01; G06F 17/30; G06F 17/15

(52) U.S. Cl. CPC G06F 17/2818; G06K 9/6289; G06F 17/15; G06F 17/30976; G06F 3/011

(57) ABSTRACT

The disclosure describes an overall system and method for designing and building multi-sense systems using a generalized synchrony based fusion technique. By treating “time” as a common thread that runs across all the modes, the invention uses trigger inputs to form several groups of inputs across all modes. The best group is selected as the one that has the maximize synchrony as determined by a combination of a weight for the group and a timing correlation of inputs within that group. The features from each mode within the best group are then used individually or jointly for pattern recognition or understanding. The result is a robust practically implementable generalized theory of multi-sense fusion. The proposed invention has immense potential to leap frog single input systems and revolutionize human-machine interactions.

### CROSS-REFERENCE TO RELATED APPLICATIONS

This patent application claims priority to U.S. Provisional Patent Application No. 62/507,365 filed May 17, 2017, which is incorporated herein by reference in its entirety.

### FIELD OF THE INVENTION

The invention relates to multiple sensory (multi-sense) systems and user interfaces (UIs) for human-machine interactions.

### BACKGROUND

Multi-sense systems have been researched for several decades now. By exploiting redundancy in inputs across multiple modes, these systems hope to be far more superior compared to their single mode counterparts. Broadly speaking, prior art approaches for combining information from different modes focus on the so-called early-fusion, mid-fusion, and late-fusion techniques. Unfortunately no prior art has been successful in proposing a seamless fusion technique that demonstrates superiority of multi-sense systems especially for real-time practical purposes. This is mainly because most of the modal inputs in the real-world occur within continuous streams that are also accompanied by noise; and hence separating the desired inputs from these streams is a problem. Almost all attempts to solve this problem have relied on manual on/off mechanism for each mode. Alternatively users could be asked to carefully synchronize their actions so that their modal inputs can be easily separated. However, both these solutions result in an overall system that is far from being seamless and hence are practically unusable.

For several years, the present inventor has been addressing the above problem. In U.S. Pat. No. 9,922,640 entitled “System and Method for Multimodal Utterance Detection” a system and method was described wherein grouping of inputs is achieved by correlating timing information between (continuous and/or discrete) inputs. The present application introduces a novel concept the inventor refers to as “synchrony”. As will be described later in detail, synchrony achieves this grouping and is more generalized and superior to inventor's earlier inventions.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an overall block diagram that illustrates components of a synchrony based multi-sense fusion system in accordance with the present application;

FIG. 2 illustrates one embodiment of fusion of multi-sense inputs for use in the synchrony based multi-sense fusion system shown in FIG. 1;

FIG. 3 illustrates one embodiment of a method for determining the best group of inputs using synchrony for use in the synchrony based multi-sense fusion system shown in FIG. 1;

FIG. 4 illustrates an example of fusion of speech and keyboard-inputs;

FIG. 5 illustrates an example of detection of “no speech” for speech and keyboard inputs;

FIG. 6 illustrates an example of rejection for speech and keyboard inputs;

FIG. 7 illustrates an example of fusion of text and keyboard inputs;

FIG. 8 illustrates an example of word-symbol pair;

FIG. 9 illustrates an example of simple editing;

FIG. 10 illustrates an example of complex editing;

FIG. 11 illustrates an example of variant of complex editing;

FIG. 12 illustrates an example of complex multiple editing;

FIG. 13 illustrates an example of multiple spoken words and gesture;

FIG. 14 illustrates an example of voice command;

FIG. 15 illustrates an example of fusion of speech and text, with speech being trigger input;

FIG. 16 illustrates some use cases of multi-sense actions;

FIG. 17 illustrates a mechanism for error correction; and

FIG. 18 is a functional block diagram representing a computing device for use in certain implementations of the disclosed embodiments or other embodiments of the method for multi-sense fusion using synchrony.

### DETAILED DESCRIPTION OF THE PREFERRED EMBODIMENT

The following disclosure describes a multi-sense system that is based on a generalized theory of multi-sense fusion using synchrony. The inspiration for the present application derives from the observation that in most human interactions, multiple senses are fused together seamlessly in a way that it all seems magical. While the exact “process” behind such form of sensory processing is obviously unknown, the inventor of the present application realized that discussions of a concept called “synchrony” in an unrelated field that has been discussed in several scientific publications may be applicable to user interfaces. For instance, in the unrelated field, it is known that to create sounds in the auditory periphery, several groups of nerve fibers lock onto the same sub-band frequency and then they all transmit precise temporal neural firings to the brain; phenomena dubbed “synchrony” by scientists modeling the auditory system. Inspired by this, the present application views all the modes as being a function of “time”, meaning, the time variable is viewed as a common thread that runs across all the modes. Then, a generalized fusion theory is developed wherein the timings of modal inputs and trigger inputs (that are automatic or manual) are used along with contextual information to group relevant inputs across multiple modes, which are then fused and recognized to yield the output.

Thus, the present application departs from strict synchronization and instead rely on synchrony (which does not require users to synchronize their inputs) to group and fuse multi-sense inputs. The beauty of the approach detailed in the present application is that it permits the design of multi-sense systems that are practically realizable and superior to existing systems. The proposed invention results in an all new multi-sense UI with increased speed, accuracy, ease of use, and overall richness of the user experience.

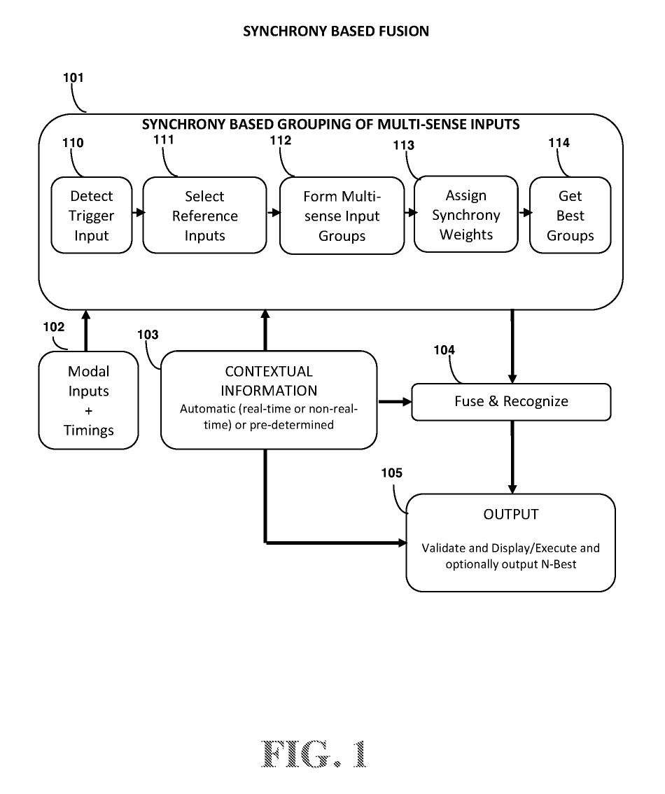

As shown in FIG. 1, the multi-sense inputs 102 that includes modal inputs and associated timings and contextual information 103 are provided to the synchrony based grouping module 101. The multi-sense inputs 102 may include speech, single touch, multi touch, gesture touch, eye features, lip features, brain thoughts and so on. The contextual information 103 may include specific characteristics of the inputs, specific rules for pattern recognition, and certain known properties of the outputs. Further, the contextual information 103 may include automatic (real-time or non-real-time) information and/or may include automatically determined or pre-determined information. The synchrony based grouping module may include a detect trigger input component 110, a select reference input component 111, a form multi-sense input groups component 112, an assign synchrony weights component 113, and a get best groups component 114. Additional components may be added without departing from the scope of the claimed invention. In addition, for processing some example modal inputs, only a subset of components 110-114 may be implemented.

Now, for discussion purpose the present application considers a text composition example. The text composition example is chosen mainly because the text composition is more challenging due to its speech+multiple touch nature compared to other examples, such as editing, maps, and the like, that usually include speech with single-touch inputs. Recall that in a text composition example, the inputs typically include key presses of the typed word, speech corresponding to the spoken word, and any other modal inputs like lip shapes or eye tracks that characterize the word. The contextual information in text composition may include input specific characteristics such as whether the word is isolated (and not a phrase) and hence its acoustics have a pre-determined duration, the absence/presence of pitch given the application vocabulary, the distribution of phonemes and the like; pattern rules like the language being spoken, the topic and language model being used, the users vocabulary that has been learned; and output specific properties like the word recognized has to have a length greater than the number of typed letters, recognition confidence and the like

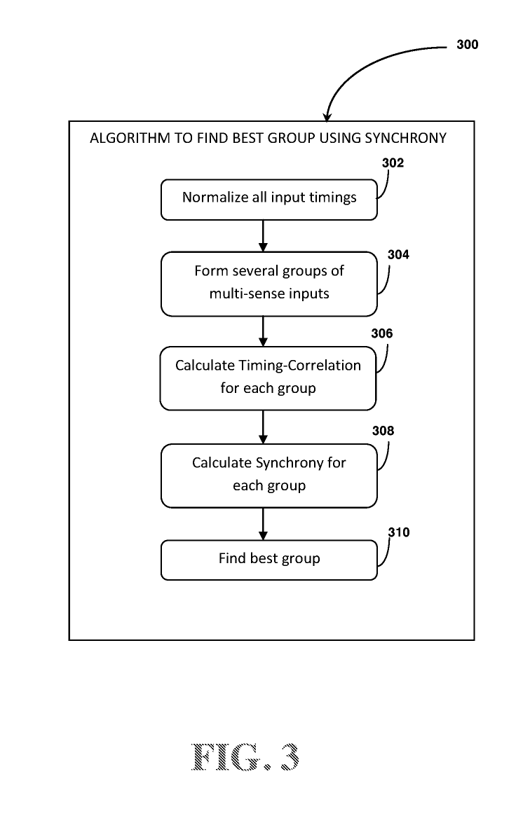

The sequence of operations of the synchrony based grouping module 101 is now discussed for the text composition example. In Detect Trigger Input component 110, if the user has typed letters of a word and then tapped the spacebar then 101 detects spacebar as the trigger input. In Select Reference Inputs component 111, given the spacebar as the trigger input all the inputs corresponding to the letters of the word typed are selected as the reference inputs. In Form Multi-sense Input Groups component 112, all permutations of inputs are considered along with the reference inputs and groups are formed. In Assign Synchrony Weights component 113, given the example of text composition, the contextual information for input such as speech input is an isolated word, speech input cannot be a click/impulse, signal-to-noise ratio (SNR) of speech input should be in a certain range and the like are used to assign weights to each group. For example, if a group has an impulse speech segment then its weight is less compared to a group with a valid speech segment. In Get Best Groups component 114, a weighted time correlation metric is used to maximize synchrony across groups and the result is declared as the best group; additional details regarding the processing that occurs in each of the components 110-114 to implement the synchrony based grouping module 101 is discussed in FIG. 3.

Once a best group is obtained using the above method, the multi-sense inputs within that best group are fused and processed in the Fuse and Process component 104. The Fuse and Process component 104 receives the best groups from the Synchrony Based Grouping Module 101. The Fuse and Process component 104 also receives information provided by the contextual information component 103. Using both of these inputs, the Fuse and Recognize component 104 yields output 105. The output 105 may be validated and displayed. In addition, the output 104 may be processed to optionally output N-Best outputs. For example, for the same text composition scenario, a dictionary of words (determined by the letters associated with the reference inputs and the context) is used to recognize the spoken word in the best group using some additional features like lip states, eye tracks, and the like that form the optional redundant modes in the best group. The output component 105 may receive information from the contextual information component 103. More generally, the contextual information may include the application specific vocabulary to be used, any reduction in vocabulary due to input from users, the language model implied by the context and so on.

The fusion and recognition may be done in real-time or non-real-time. In real-time, all speech is transcribed before receiving the trigger input where for non-real-time, the utterance is only separated from the continuous stream on receiving a trigger input and this is recognized after receiving the trigger input. Some of the problems associated with real-time implementation is the heavy processing requirements and the high recognition of errors due to the lack of contextual information. Some of the problems with non-real-time is the delay incurred due to the processing done post receiving the trigger input.

Finally the output module 105 validates the recognized word using rules associated with the context discussed earlier. If the word is invalid the output is replaced by the next best group determined by get best groups component 114 and validation is repeated. This cycle is repeated until a valid word is found; if no valid words are found, a rejection is indicated.

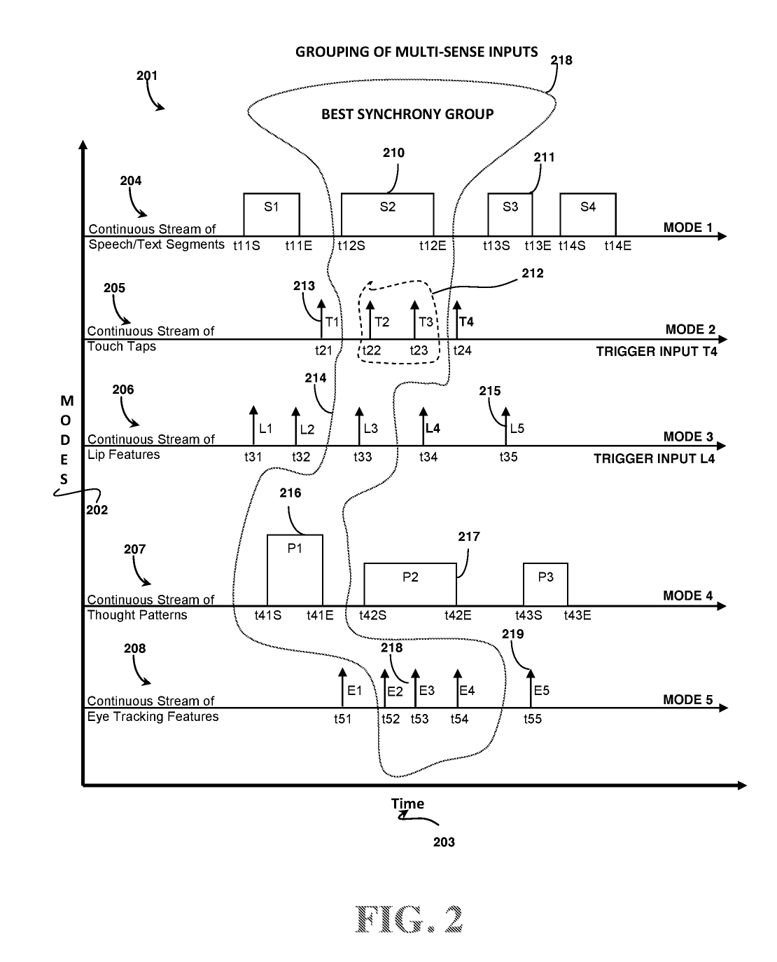

FIG. 2 is an exemplary graphical representation for at least one embodiment a grouping process 201 that may be implemented within the synchrony based grouping module 101 shown in FIG. 1. The x-axis represents Time 203. The y-axis represents several different input modes 202. While the exemplary graphical representation displays several input modes, those skilled in the art will appreciate that other input modes may be similarly represented. However, for ease of explanation, only a few input modes are shown in FIG. 2. For simplicity, FIG. 2 represents the input modes involved with test composition.

First, a continuous stream of audio recording 204 that includes several speech/noise segments S1, S2, S3, and S4. Of these segments, segment S2 is the segment corresponding to the user's spoken word (let's call it “UserWord”), associated with reference number 210. Note that segment S2 also corresponds to the word being typed by the user (as shown by touch taps 205) since we are considering an example where user speak-and-types words. Segments S1, S3, and S4 could be background noise, user's undesired speech, other background speech etc.

A stream of touch taps 205 is shown on the line below the continuous stream of audio recordings 204. The stream of touch taps 205 includes key taps T1, T2, T3, and T4. Key taps T2 and T3, grouped together and denoted with reference 212 (part of touch taps 205) correspond to the user's typed word (i.e., typing of UserWord 210) and key tap T4 corresponds to the tapping of the spacebar by the user indicating an end of word. Key tap T1 could be taps delimiting the word from a previous word or symbol.

The present application may incorporate any number of input modes 202. FIG. 2 further illustrates input modes 206, 207, and 208, each of which provide further redundancies. In FIG. 2, input mode 206 represents a continuous stream of lip features, input mode 207 represents a continuous stream of thought patterns, and input mode 208 represents a continuous stream of eye tracking features. For example, lip feature L3 may be the shape of the user's lips while speaking UserWord 210, thought pattern P1 may be the thought pattern corresponding to UserWord 210, and eye features E2, E3, E4 may be eye tracks of the user while speaking-and-typing UserWord 210. All the other inputs that are not within the shaded portion in FIG. 2, namely lip features L1, L2, L5, thought patterns P2, P3, and eye features E1, and E5 may be considered as interference/noise.

In one embodiment, touch taps and lip features may represent trigger modes. For example, in FIG. 2, touch tap T4 may represent the tapping of a spacebar and lip feature L4 may represent the closing of lips after speaking UserWord. Both of these may then be used as trigger modes, thereby, resulting in touch tap T2 and T3 and lip feature L3 representing the reference inputs associated with these trigger inputs. Those familiar with art will recognize that other modes may be used as trigger modes depending on the particular application. For example, speech mode could be a trigger mode instead of having the touch tap be the trigger mode.

Based on the discussions presented for FIG. 1 and using the above description for FIG. 2, a “best group” 218 is formed based on the inputs shown in FIG. 2 and the processing as performed in the synchrony based grouping module 101 shown in FIG. 1. Details for forming the “best group” 218 will now be discussed with reference to FIG. 3.

FIG. 3 illustrates a process 300 for finding the best group using synchrony. For the following discussion, process 300 represents each mode as m1, m2 and so forth. The total number of modes is represented with M2 Each candidate input in mj is denoted as Cij where i=1, 2 . . . Cj and Cj=total number of inputs for mj.

At block 302, all timings in all modes are normalized. There are several ways one could achieve this. In case of single discrete inputs, it is fairly straightforward since there is only one time to work with for each discrete input. To normalize this one can simply take into account the reference time and subtract that from the input's time; or use other normalization techniques. In case of continuous inputs, one can either use two timings for each input or to simplify things map the start and end times to one time using a heuristic as follows: if mj consists of continuous input segments, map all its segments start times (S), tjiS, and end times (E), tjiE, to a single time tji=(tjiS+tjiE)/2. Those familiar with art will recognize that the heuristic used to compute tji essentially maps the start and end times to a single time at the mid-point of the i-th segment in the j-th mode; and several variants of this as well as other heuristics may be employed instead; some more examples include tji=tjiS, tji=tjiE, tji=f(tjiS, tjiE) and the like. Similar to normalization of discrete input timings, tji may be normalized. Note that the continuous inputs case may be extended to the case of multiple discrete inputs grouped together. For instance, the three inputs grouped together in 218 shown in FIG. 2 as eye features E2, E3, E4 can have their times t52, t53, and t54 mapped to one single time as t5=(t52+t53+t54)/3 or t5=t52 or t5r=f(t51, t52, t54) and so on. Alternatively, the case of multiple times for an input may be also dealt by incorporating special heuristics in the correlation calculation discussed later. More generally, the mapping of multiple times may be addressed in a way that best suits the application under consideration.

At block 304, process 300 forms groups of multi-sense inputs. To do that, process 300 fixes the reference inputs from the trigger-modes (determined by the trigger inputs) and takes permutations of all other inputs from the non-trigger modes and form groups. For example, the shaded area in FIG. 200 is a group formed by keeping the reference inputs touch taps (T2, T3, L3) fixed and considering stream S2 from m1, thought pattern P1 from m4, and eye features (E2, E3, E4) from m5, so as to yield the Group-shaded: (T2, T3), L3, P1, (E2, E3, E4).

At block 306, process 300 computes the timing-correlation (TC) for all the groups and denote that as TCg . . . g=1, 2, 3, G (where G is the total number of groups possible). Those familiar with art will appreciate that there are several ways to compute correlations. One way to do so especially for the same example of the shaded region of FIG. 200 is: TC-shaded=[(t12S+t12E)/2]−[(t22+t23)/2]−t3−[(t42S+t42E)/2]−(t52+t53+t54)/3.

At block 308, process 300 computes the synchrony, Sg, for each group g. Once again, there are several ways to construct formulas and heuristics to define synchrony, and one such way is shown here (for the shaded area in FIG. 200) as (Sg=Wg−TCg) where Wg is a weight for group g.

At block 310, process 300 finds the best group by maximizing the synchrony as S*=max of Sg=max {Wg−TCg} for all g. The group that has S* as the synchrony is then the best group gB. If multiple groups have the same value then output all the choices in an “N-Best” array. If gB does not match a selection criterion, output the next Best or Reject all groups. The selection criterion is set by the context. For instance, use of features like speaker-specific pitch for match user's speech; knowledge of email context to constrain certain types of words, knowledge of search context to match common search phrases, music context to match songs, SNR is the context has high sounding sounds, flight booking context words and the like.

Those familiar with art will recognize that the formula for synchrony may be replaced by several others so as to suit the specific scenario. For instance, S*=max {Wg/TCg} for all g or min {Wg*TCg} for all g. Those skilled in art will recognize that the contextual information may be completely ignored and the invention may be simply used by minimizing a time-correlation measure i.e. min {TCg}. More generally, one may construct equation that quantify certain properties like: (a) find the speech segment closest to the reference inputs and with an SNR between 5 dB and 20 dB, (b) what's the speech segment closest to the timing of a double-tap on a text-view screen?, (c) find a cluster of letters typed that are closest to a trigger spoken word “San Francisco” such that the inputs in the cluster are not separated by more than a second, and so on.

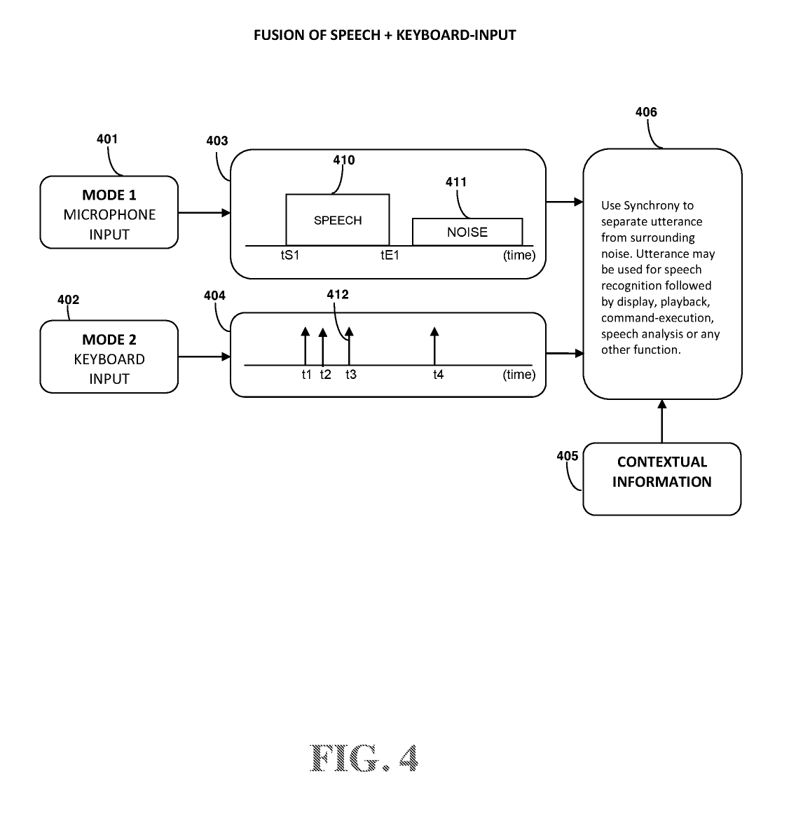

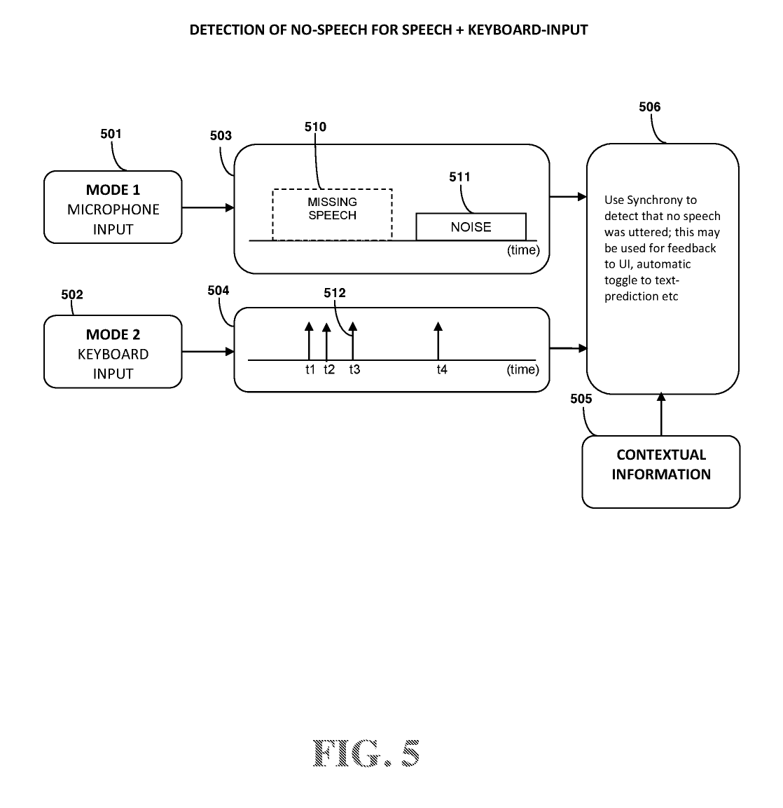

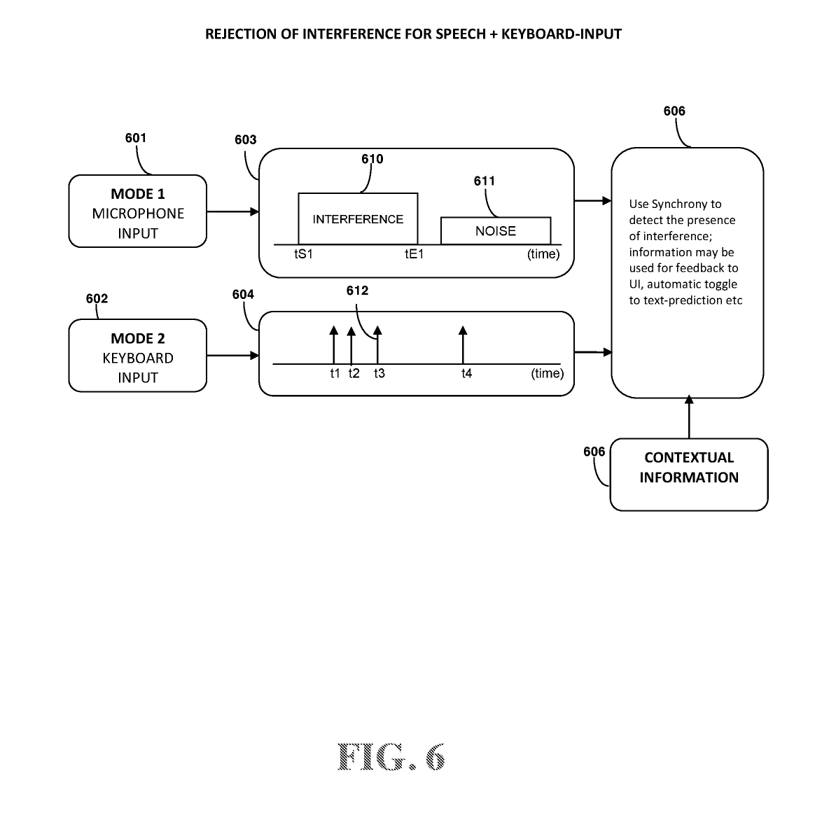

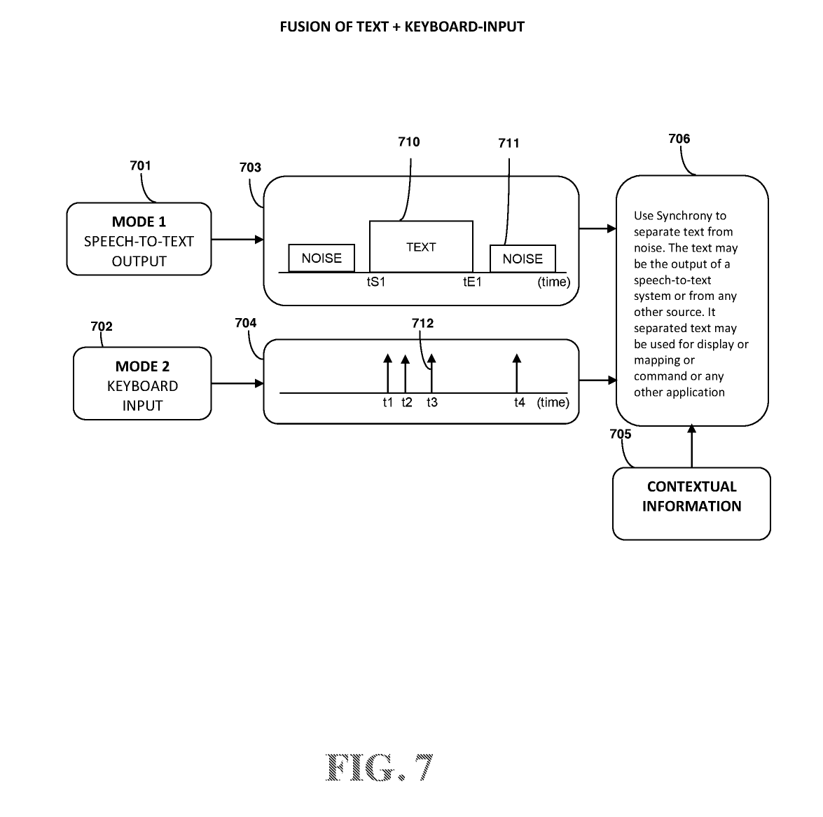

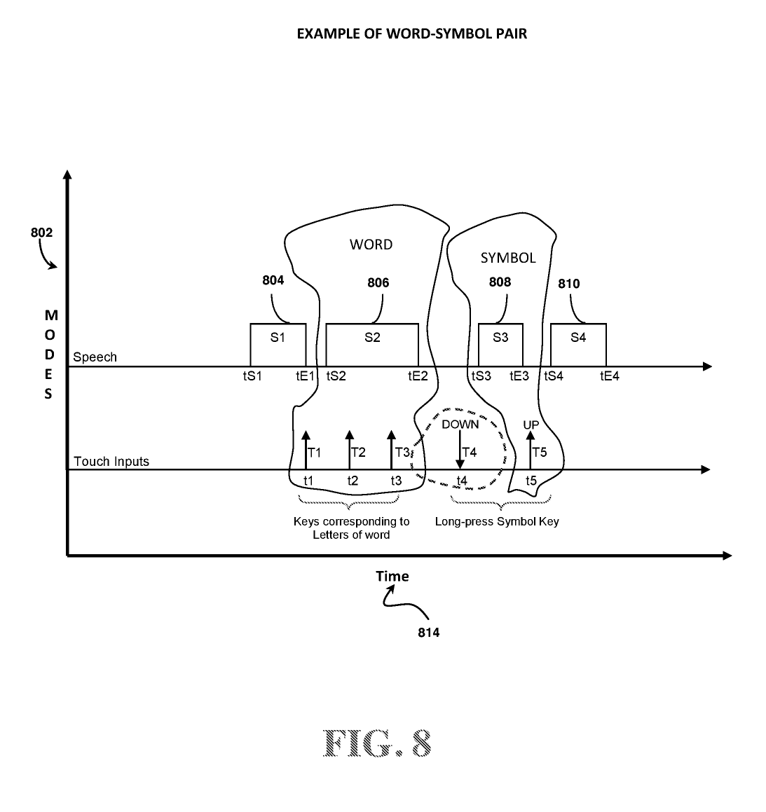

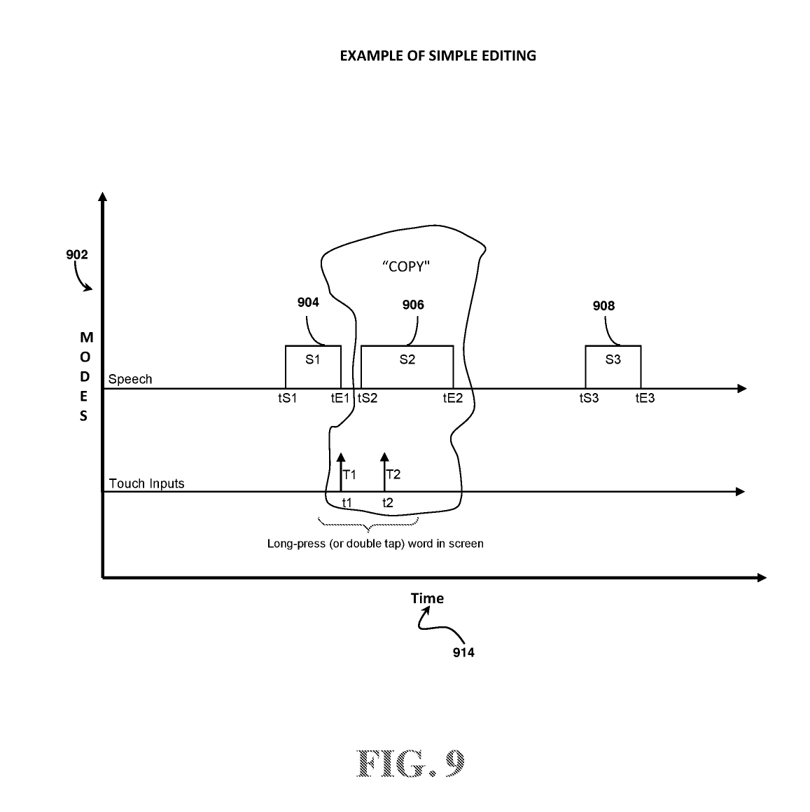

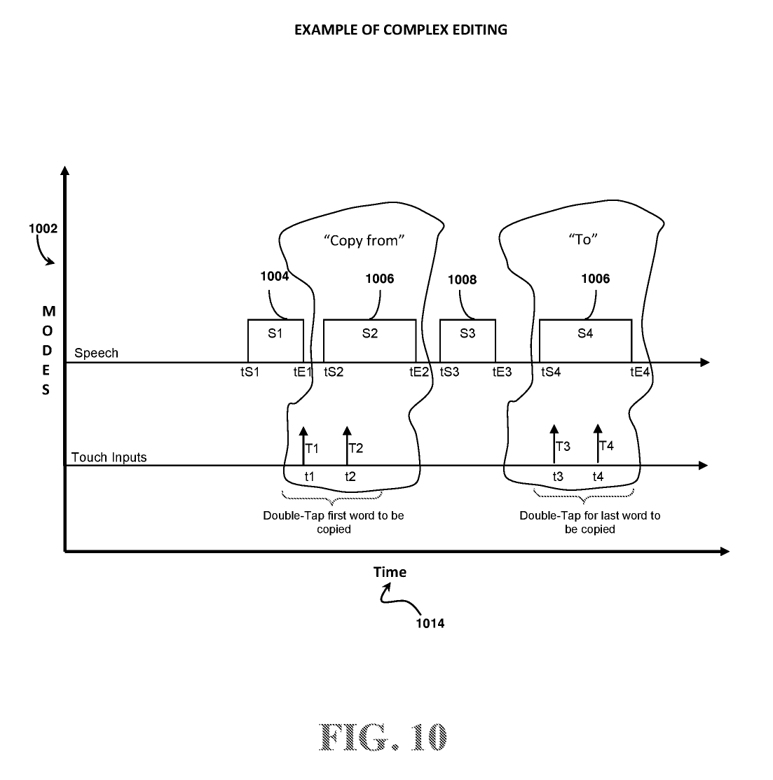

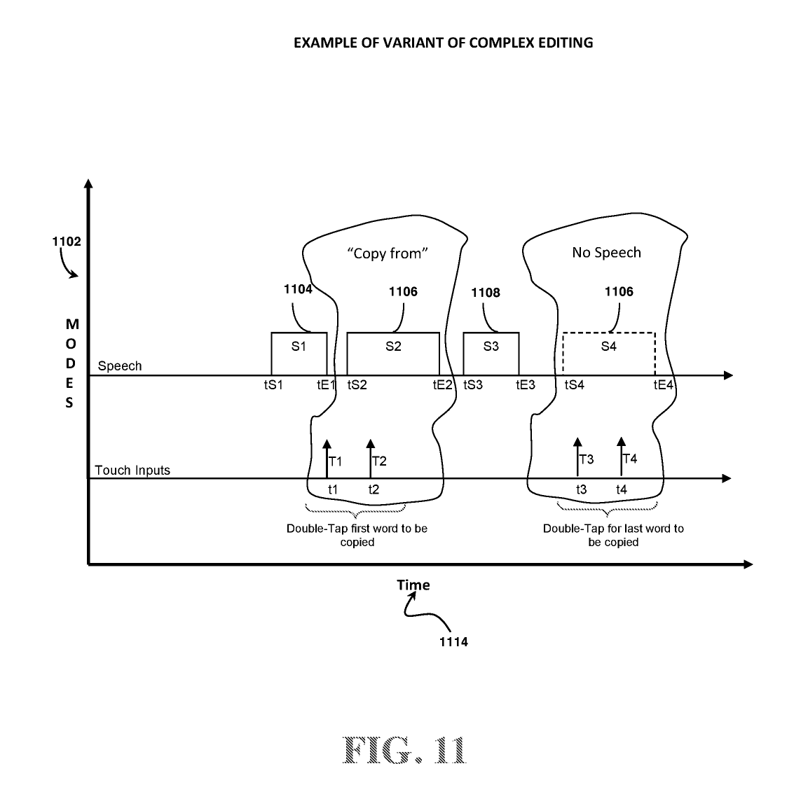

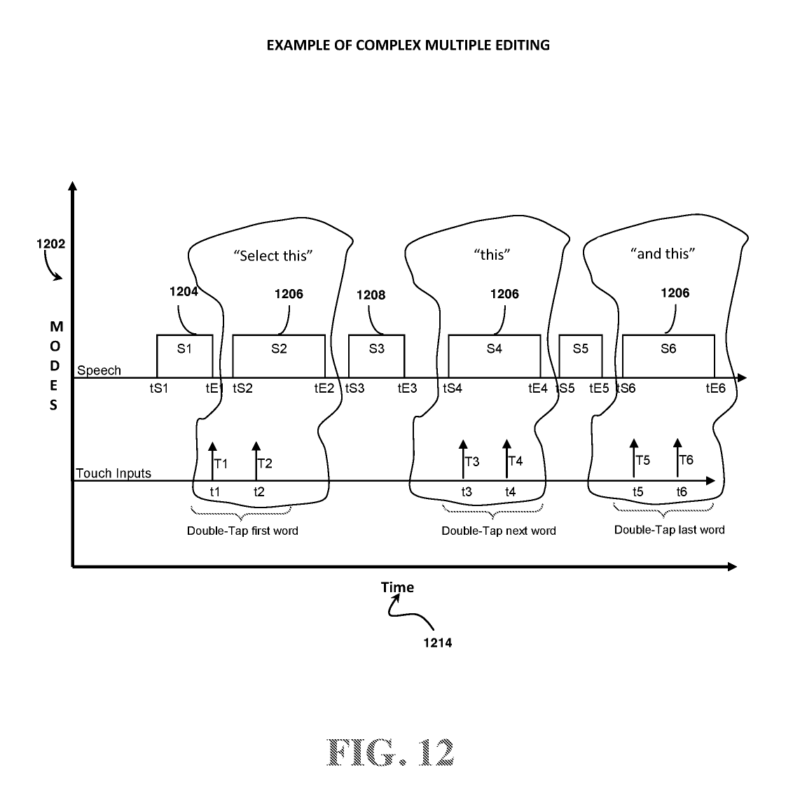

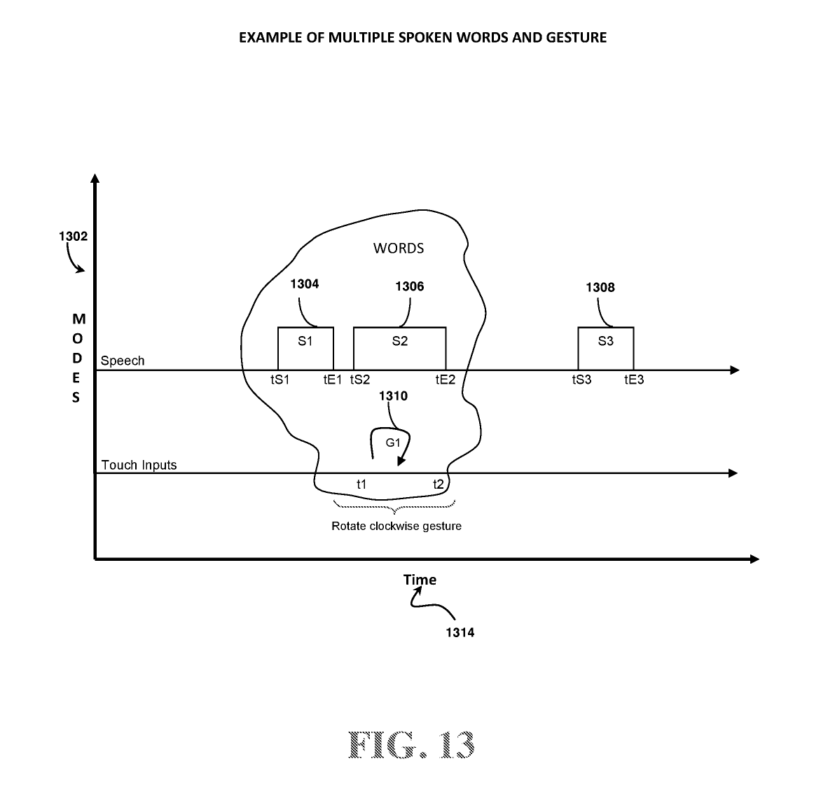

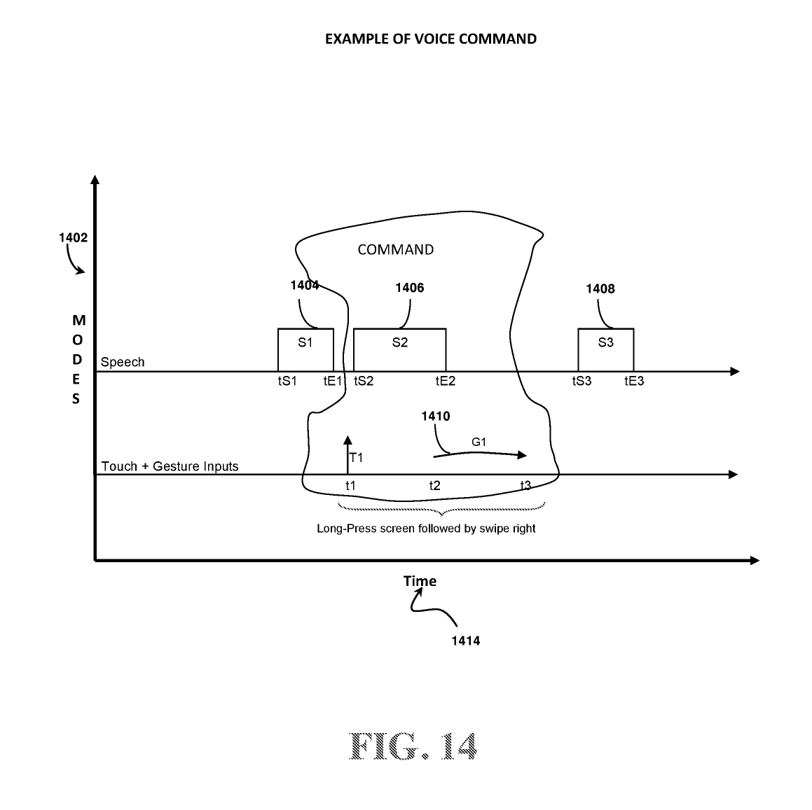

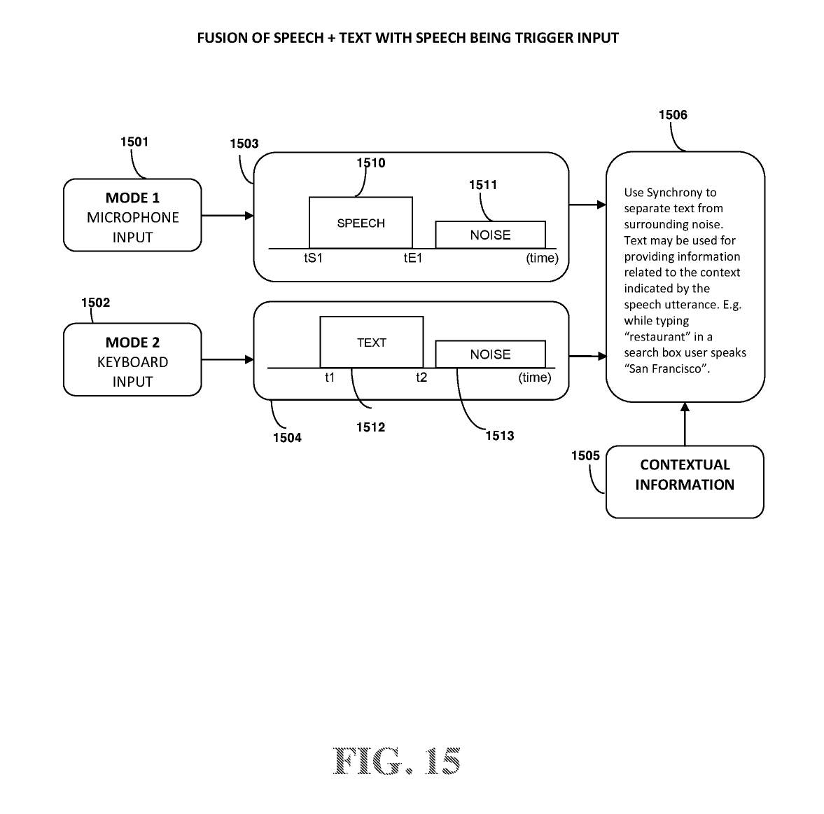

FIGS. 4-6, illustrate the present system's ability to back-off to single mode automatically and also its ability to reject interference. Observe that if a user provides no speech input then this is detected by the synchrony measure or in the fusion module; and the system falls back to using only trigger inputs for recognition (e.g., fusion is discarded and the system falls back to standard text prediction). FIGS. 7-15 illustrate different examples that demonstrate the applicability of the present invention to a variety of different scenarios. One of them is now considered and explained. FIG. 13 illustrates an example of multiple spoken words and gesture. For example, the user may say a command (e.g., “Rotate 45”) while doing a clockwise-rotate gesture on an image icon (represented on the Touch Inputs line). In that case the trigger input is denoted as G1. It so happens that in this case the reference input indicated by G1 is also G1. Hence the system groups the spoken words S1 and S2 and with the context information that it's a command, recognizes the words and rotates the image clockwise by 45 degrees.

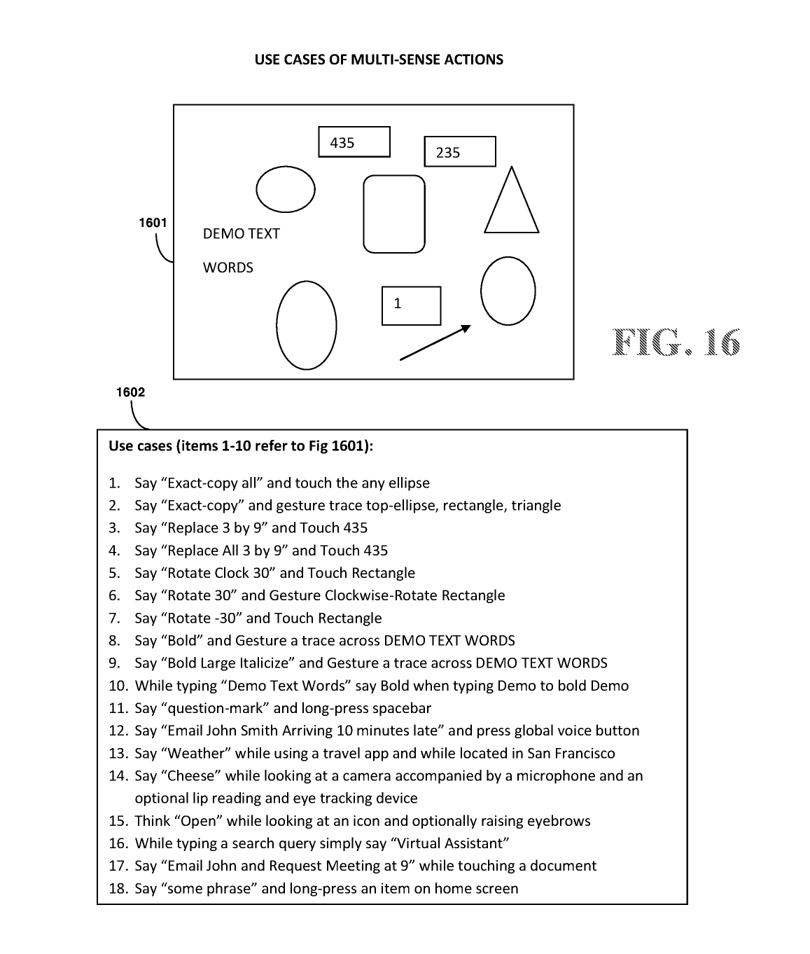

FIG. 16 lists some use cases in which the method multi-sense fusion using synchrony may be implemented as described in the present application. A screen 1601 is considered as an example UI with which a user interacts. Several use cases are listed in 1602. Some example items that are listed in 1602 are now further described. For example, use case item 11 represents if a user does not type letters but simply uses long-press-spacebar then contextual information indicates a symbol mode and trigger input i.e., long-press-spacebar becomes the same as reference input (although the onPress and onRelease actions may be separated). Use case item 12 represents if user presses a dedicated voice button then the release of that button implies a contextual information of global commands. Use case item 13 represent if a user is using a travel app and says “Weather” while located in San Francisco then the speech acts as a trigger input whereas location, and travel app act as context. Use case item 18 represents when trigger-inputs are ignored because the long-press was received for an item in a home-screen.

An interesting observation is that the present application may be used with multiple modes which opens up possibilities for advanced forms of human-machine interactions. For instance, non-linear editing is possible using this invention wherein multiple objects can be modified while keeping their relative positions with respect to other objects same. This is shown on 1602 in use cases items 1, 2, and 3. The “Exact” command is used to indicate to the system to maintain relative positions in memory so it can be used later (e.g., to paste all ellipses with the same relative positions). In use case item 3 of 1602, all occurrences of “3” are replaced by “9” while maintaining all other digit positions.

The present application may also be used for another interesting scenario as shown in use case item 9 of 1602 in FIG. 16: user says “Bold Large Italicize” while swiping finger across the entire text “Demo Text Words” on the screen, the system recognizes all 3 commands and fuses them with the swipe gesture and carries out the action on the line of text. Those familiar with art will recognize that a plethora of use-cases exist for which the present application is applicable.

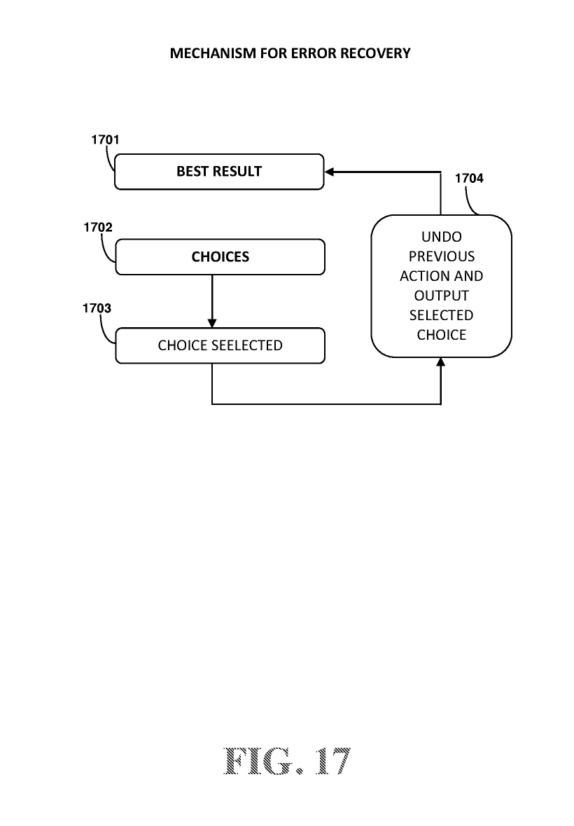

FIG. 17 illustrates a mechanism for error recovery to recover from errors in the proposed multi-sense system. Observe that along with the best result (which could be text or an object displayed or an action performed) 1701, choices ordered as 2′ best, 3′ best and so on are also displayed by the UI in 1702. If the user taps one of the choices (because the best result is incorrect) 1703, then 1704 undoes the action performed for the best result and performs a new action as dictated by the choice selected.

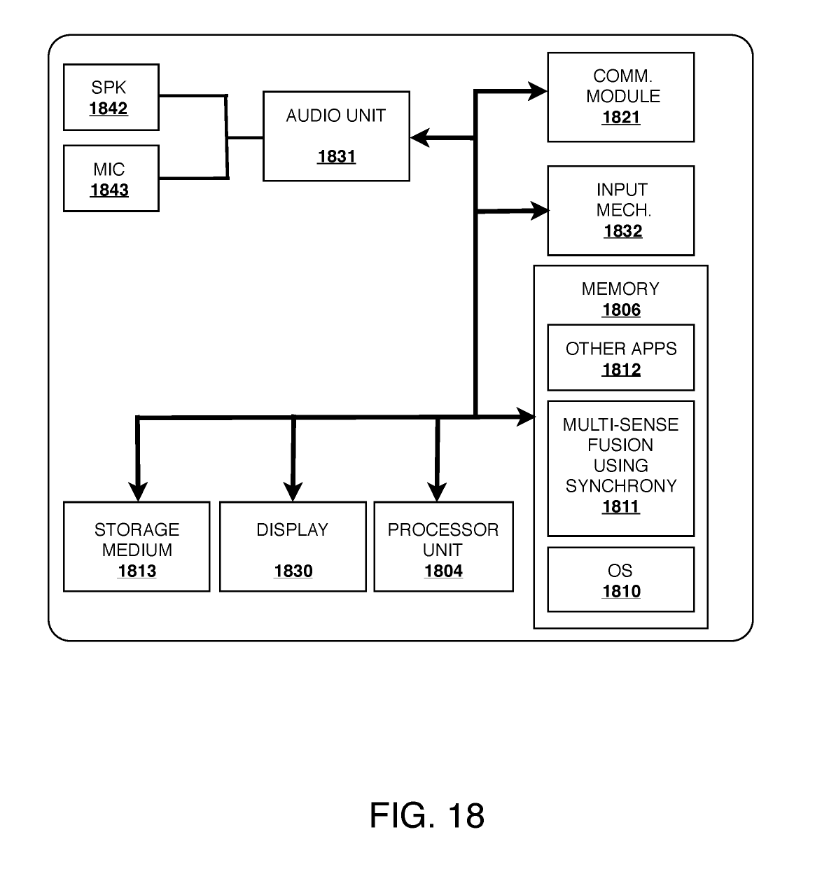

FIG. 18 is a functional block diagram representing a computing device for use in certain implementations of the disclosed embodiments or other embodiments of the method for multi-sense fusion using synchrony. The mobile device 1801 may be any handheld computing device and not just a cellular phone. For instance, the mobile device 1801 could also be a mobile messaging device, a personal digital assistant, a portable music player, a global positioning satellite (GPS) device, or the like.

In this example, the mobile device 1801 includes a processor unit 1804, a memory 1806, a storage medium 1813, an audio unit 1831, an input mechanism 1832, and a display 1830. The processor unit 1804 advantageously includes a microprocessor or a special purpose processor such as a digital signal processor (DSP), but may in the alternative be any conventional form of processor, controller, microcontroller, state machine, or the like.

The processor unit 1804 is coupled to the memory 1806, which is advantageously implemented as RAM memory holding software instructions that are executed by the processor unit 1804. In this embodiment, the software instructions stored in the memory 1806 include a multi-sense fusion using synchrony method 1811, a runtime environment or operating system 1810, and one or more other applications 1812. The memory 1806 may be on-board RAM, or the processor unit 1804 and the memory 1806 could collectively reside in an ASIC. In an alternate embodiment, the memory 1806 could be composed of firmware or flash memory. The memory 1806 may store the computer-readable instructions associated with the multi-sense fusion using synchrony method 1811 to perform the actions as described in the present application.

The storage medium 1813 may be implemented as any nonvolatile memory, such as ROM memory, flash memory, or a magnetic disk drive, just to name a few. The storage medium 1813 could also be implemented as a combination of those or other technologies, such as a magnetic disk drive with cache (RAM) memory, or the like. In this particular embodiment, the storage medium 1813 is used to store data during periods when the mobile device 1801 is powered off or without power. The storage medium 1813 could be used to store contact information, images, call announcements such as ringtones, and the like.

The mobile device 1801 also includes a communications module 1821 that enables bi-directional communication between the mobile device 1801 and one or more other computing devices. The communications module 1821 may include components to enable RF or other wireless communications, such as a cellular telephone network, Bluetooth connection, wireless local area network, or perhaps a wireless wide area network. Alternatively, the communications module 1821 may include components to enable land line or hard wired network communications, such as an Ethernet connection, RJ-11 connection, universal serial bus connection, IEEE 1394 (Firewire) connection, or the like. These are intended as non-exhaustive lists and many other alternatives are possible.

The audio unit 1831 is a component of the mobile device 1801 that is configured to convert signals between analog and digital format. The audio unit 1831 is used by the mobile device 1801 to output sound using a speaker 1842 and to receive input signals from a microphone 1843. The speaker 1832 could also be used to announce incoming calls.

A display 1830 is used to output data or information in a graphical form. The 1830 display could be any form of display technology, such as LCD, LED, OLED, or the like. The input mechanism 1832 may be any input mechanism. Alternatively, the input mechanism 1832 could be incorporated with the display 1830, such as the case with a touch-sensitive display device. The input mechanism 1832 may also support other input modes, such as lip tracking, eye tracking, thought tracking as described above in the present application. Other alternatives too numerous to mention are also possible.

Those familiar with art will recognize that the invention may be modified to incorporate natural language processing (NLP) and language understanding as well. For example, the voice command may be a phrase/query or an entire instruction to a computer to execute an operation. The system then uses AI techniques to extract semantics from voice using fusion from other modal inputs.

Those familiar with speech recognition will recognize that the proposed invention addresses problems associated with “chopping of utterances” in current speech input systems using on/off switch; since speech is continuously recorded and later separated using synchrony the chopping problem is eliminated in the proposed invention. Furthermore the continuous recording of the proposed invention also yields better estimates of background noise and channel noise and hence improves accuracy of speech recognition; and speed of recognition since there are no noise estimation delays in systems with manual on/off modes.

Those familiar with art will further recognize that several extensions of the proposed invention may be developed to address several application scenarios including word processing like word, financial software like excel, presentation software like power-point, maps software, project software, operating system UI, hands-free eyes-free UI, virtual reality systems with eyes+voice+gestures and so on. Further, the invention may also be used within certain signal/data and image processing algorithms; for instance multiple channel signal separation in multi-directional inputs (mono, stereo, beam forming), biometric systems, speech feature analysis (sub-band speech features may be fused together using the synchrony proposed in this invention along with Pitch and/or amplitude modulations as trigger inputs), pitch extraction, music synthesis, biometrics etc.

The claimed invention is:

1. A system for grouping multiple sensory inputs using synchrony, comprising:
a module for computing correlation metrics;
a module for computing weights;
a module for computing a measure of synchrony using correlation metrics and weights;
and a module for yielding the best group of inputs based on the synchrony measure and a module for yielding the best group of inputs based on the synchrony measure.

2. A method for grouping multiple sensory inputs using synchrony, comprising:
computer-readable instructions for computing correlation metrics;
computer-readable instructions for computing weights;
computer-readable instructions for computing a measure of synchrony using correlation metrics and weights; and
computer-readable instructions for determining the best group of inputs based on the synchrony measure.
